(19) United States
(12) Patent Application Publication
(10) Pub. No.: US 2006/0148631 A1
(43) Pub. Date: Jul. 6, 2006

(54) Manufacturing line for making corrugated cardboard

(75) Inventors: John R. Protocsnak, Orland Park, IL (US); David J. Roberts, Oak Lawn, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: CORRUGATED SUPPLIES CORPORATION

(21) Appl. No.: 11/026,875

(22) Filed: Dec. 30, 2004

(51) Int. Cl. B31F 1/20

(52) U.S. Cl. 493/463

(57) ABSTRACT

A manufacturing line for making corrugated paper has both a conventional feed stock location where stock is fed to the line and a gluing station where the stock is connected to the corrugated medium. The line includes multiple in-line printers that are positioned between the feed stock location and the gluing station. One printer can be used to print a first color or coating on a first portion of the stock, and another printer can be used to print a second color on a second portion of the stock. A center trim pickup can be used to divide the paper stock between the two portions.

### BACKGROUND OF THE INVENTION

The present invention relates generally to machines for making corrugated cardboard, and more particularly to machines for making cardboard with a colored or printed liner.

While corrugated cardboard is generally brown in color, it has been known that it can also be made in other colors or with printed or coated surfaces. Conventionally, these products have been made in either of two ways.

One common way to produce colored or printed cardboard is by replacing the conventional brown stock fed to the corrugating machine with colored or printed stock. One problem with this method is that there can be significant waste when the width of the roll does not match the required width of the sheet or when the color or printing is not needed on the entire roll. Another problem involves storing all the various colored or printed stock that may be required over a period of time, and the time and effort needed to change the stock rolls every time a new color is to be used.

Another common way to produce colored or printed cardboard is by printing the board after it is manufactured. While this solution solves the waste and storage problems associated with coloring or printing the paper stock before it is made into cardboard, it suffers from other problems. Printing on finished cardboard applies pressure to the cardboard, and can damage it. Also, the quality of the color is affected by the flutes of the corrugation.

Conventional flexographic coating and/or printing machines or presses have one or more image-printing stations, each with a flexographic plate having raised image (or printing) areas. Aqueous or solvent ink is applied to the raised image areas, and the ink is transferred directly to the cardboard or web. A standard, web-fed flexographic machine (as well as standard lithographic printers) require the material to be printed to wrap around and over plate cylinders or impression cylinders. Consequently, stiff, heavyweight cardboard sheets, such as corrugated cardboard, cannot be printed on such printers. Instead, flexographic “sheet-fed” printing machines are generally employed for printing corrugated cardboard.

While some manufacturers may have considered or tried to incorporate an in-line printer within the corrugating machine itself, it is believed that no one has previously developed a manufacturing line that offers the efficiency of a line that can produce multiple colors or printings in-line, on standard stock, on all or partial portions of the stock.

### BRIEF SUMMARY OF THE INVENTION

The applicants have developed a manufacturing line that offers that efficiency. Like conventional corrugated paper assembly lines, the line has both a paper feed stock location where stock is fed to the line and a gluing station where paper from the feed stock location is joined to the corrugated medium. Unlike previously-known assembly lines, the new line includes multiple in-line printers that are positioned between the feed stock location and the gluing station.

One printer can be used to print a first color or coating on a first portion of a paper stock running through the machine, and another printer can be used to print a second color or coating on a second portion of the paper stock. A center trim pickup can be used to divide the paper stock between the two portions. In using the new line with a conventional 98″ web, high-quality, 36″-wide cardboard colored or printed to one customer's order can be made simultaneously with high-quality, 48″-wide cardboard that is either plain or colored or printed to another customer's order, without significant waste or the need to pre-print or store special stock rolls.

### BRIEF DESCRIPTION OF THE DRAWINGS

One embodiment of the invention is disclosed in the accompanying drawings, in which:

FIG. 1A is a plan view of one end of a manufacturing line for making corrugated cardboard;

FIG. 1B is a plan view of the other end of the line seen in FIG. 1A;

FIG. 2 is an enlarged elevational view of a section of the line seen in FIG. 1A;

FIG. 3 is a plan view of the section of the line seen in FIG. 2;

FIG. 4 is an enlarged, cross-sectional view of one of the printers seen in FIG. 3; and

FIG. 5 is an enlarged plan view of the slitting station seen in FIG. 1B.

### DETAILED DESCRIPTION

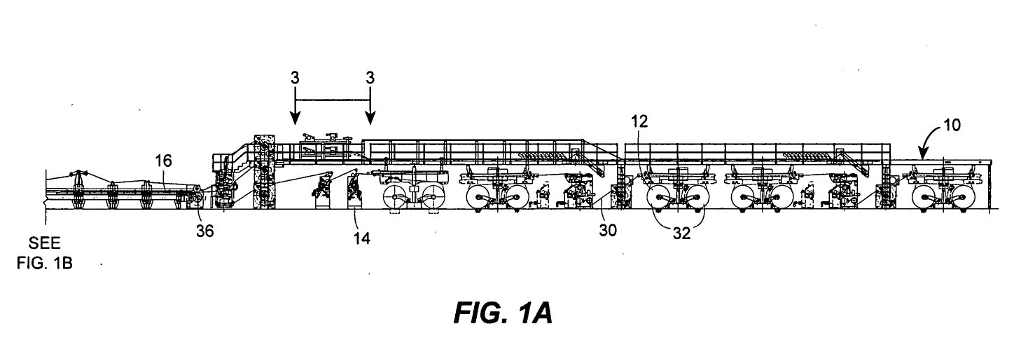

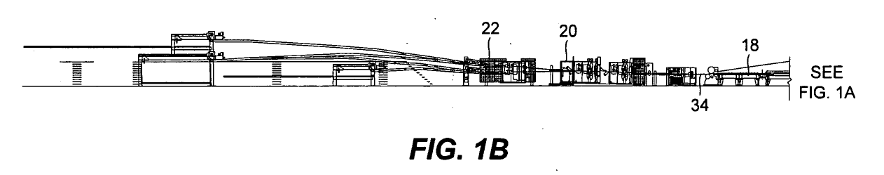

The figures illustrate one embodiment of a manufacturing line 10 in accordance with the present invention. The line seen in FIG. 1 includes a feed stock location 12, a printing station 14, a gluing station 16, a drying station 18, a slitting station 20, and a bundling station 22.

Many aspects of the illustrated manufacturing line are conventional. A paper web 30 begins at the paper stock feed location 12, where the web is fed to the line from large stock rolls 32.

The web 30 winds its way to the gluing station 16, where it is adhered to a corrugated medium to form a rigid board 34 having the common corrugated structure. The illustrated gluing station uses conventional heat-set, corn starch-based adhesive technology, where the adhesive is metered onto an applicator roll 36 to be applied to the flute tips of a single face web. After being glued, the board 34 passes to the drying station 18 where it is cured. The cured board is then cut to width and then to length at the slitting station 20. The cut board then moves to the bundling station 22 where it is bundled for shipment to customers. In other facilities, folding stations could also be incorporated into the line.

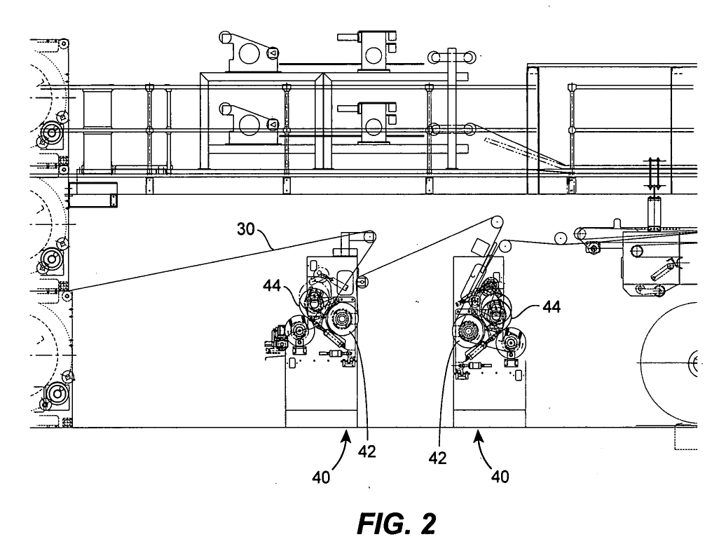

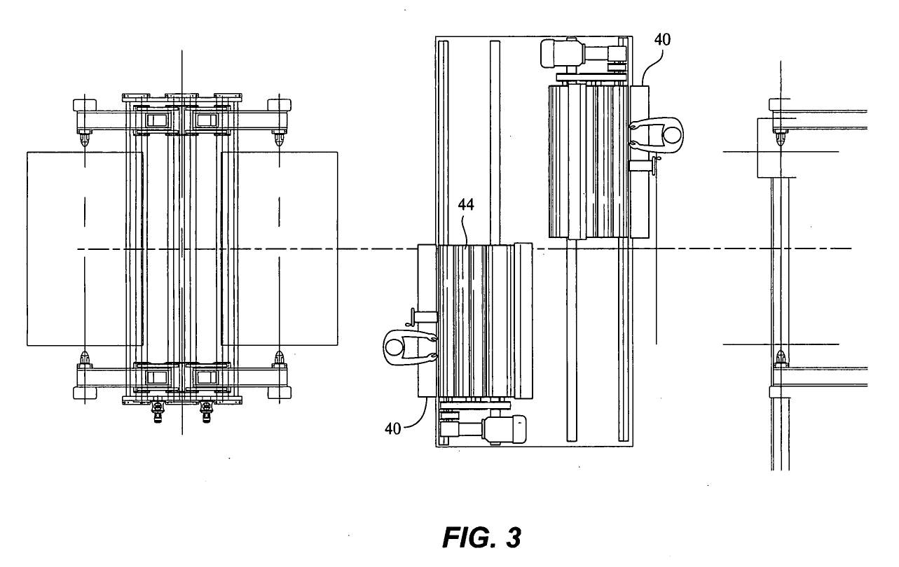

The printing station 14 seen in detail in FIGS. 2-4 is believed to be a unique and particularly advantageous part of the line. The printing station is located between the paper stock feed location 12 and the gluing station 16, and thus receives the flexible web 30 before it is joined to the medium.

The illustrated printing station 14 includes two web-fed, in-line printers 40. In other situations, more printers could be added. The illustrated printers are permanently mounted in place, but in other situations the printers could be movable. The illustrated printers are flexographic printers, and each has an impression cylinder 42 and a plate roll 44. The web 30 is wound around the impression cylinder. The plate roll carries the coating or tint that is transferred to the web as it passes around the impression cylinder.

The illustrated printers 40 can be used in many ways. For example, when printing the full width of the web 30, one printer may be used to print one color or coating, and the other printer can be used to print a second color or coating. The printers may be electronically synchronized to run two-color registered print jobs. Alternatively, if less than the full width of the web is needed for one customer's order, one printer can be used to print one color or image for that customer on one portion of the web, while the other printer is used to print another color or image for another customer on another, adjacent portion of the web.

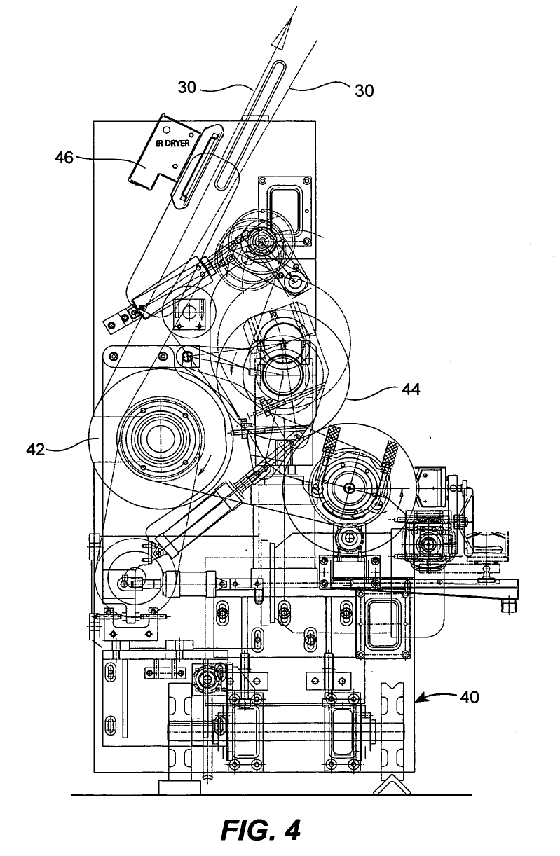

The illustrated printing station 14 also includes an optional drier 46 (FIG. 4) associated with each printer 40. The illustrated driers are infrared driers, and can be used to dry the ink or coating on the web 30 before the web passes over the next roller. In many situations, the use of a drier may help to prevent smudges, improving the quality of the printing. However, driers may not always be required, and other types of driers might also be used as needed.

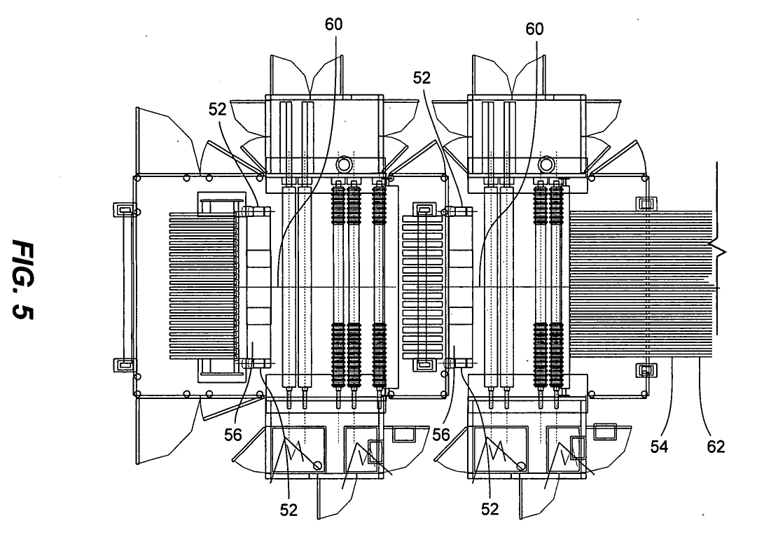

The slitting station 20 seen in FIG. 5 is also believed to be unique. While the slitting station includes conventional side trim pickups 52 near the outer edges 54 where the assembled board passes, it also includes a center trim pickup 56 between those edges. The center trim pickup includes blades 60 that can be adjusted to remove a variable-width middle trim blank from the board. Use of this center trim pickup enables the trim line 62 for the outer edges of the board to be maintained at a constant position even when the width of the job(s) being produced changes. For example, when one of the printers 40 is being used to print a 60″ wide job on one portion of the web, and another printer is being used to print a 26″ wide job on the opposite side of the web, the use of the center trim pickup may allow the line to be adjusted to print a 28″ wide job with the second printer without needing to adjust the trim line for the outer edges of the board.

This description has been provided for descriptive purposes. Those skilled in the art may recognize that many modifications can be made without departing from the spirit or scope of the invention, which is set forth in the following claims.

What is claimed is:

1) A manufacturing line for making corrugated paper comprising multiple web-fed, in-line printers.

2) Corrugated paper made on the line recited in claim 1.

3) A manufacturing line for making corrugated paper comprising:
a feed stock location where stock is fed to the line;
a gluing station where a web from the feed stock location is connected to a corrugated medium; and
multiple in-line printers between the feed stock location and the gluing station.

4) A line as recited in claim 3, in which the in-line printers are web-fed printers.

5) A line as recited in claim 3, in which the printers are flexographic printers.

6) A line as recited in claim 3, in which:
the printers have at least one cylinder around which the web is wound.

7) A line as recited in claim 3, in which:
the printers are flexographic printers: and
a drier is provided between the printers.

8) The line as recited in claim 3, in which the printers are connected in a manner enabling them to be electronically synchronized to run two-color registered jobs.

9) Corrugated paper made on the line recited in claim 3.

10) A manufacturing line for making corrugated paper comprising:
means for printing a first color or coating on a first portion of a web running through the line; and
means for printing a second, third, or fourth color on a different portion of the web.

11) A line as recited in claim 10, in which:
the line further comprises a center trim pickup that can be used to divide the web along its length into two web sections;
the means for printing the first color or coating comprises means for printing on a portion of the web corresponding to one of the two web sections; and
the means for printing the second, third, or fourth color comprises means for printing on a portion of the web corresponding to a different web section.

12) The line as recited in claim 10, in which the printers are connected in a manner enabling them to be electronically synchronized to run two-color registered jobs.

13) Corrugated paper made on the line recited in claim 10.

14) A manufacturing line for making corrugated paper comprising:
means for printing a first color or coating on a first portion of a web running through the line; and
means for printing a second, third, or fourth color on the same portion of the web.

15) The line as recited in claim 14, in which the printers are connected in a manner enabling them to be electronically synchronized to run two-color registered jobs.

16) Corrugated paper made on the line recited in claim 14.
